(19) United States
(12) Patent Application Publication
(10) Pub. No.: US 2025/0158741 A1
(43) Pub. Date: May 15, 2025

(54) PEAK-TO-AVERAGE POWER RATIO BASED FREQUENCY INTERLEAVING

(71) Applicant: QUALCOMM Incorporated, San Diego, CA (US)

(72) Inventors: David YUNUSOV, Holon (IL); Amit BAR-OR TILLINGER, Tel-Aviv (IL); Peer BERGER, Hod Hasharon (IL)

(21) Appl. No.: 18/505,618

(22) Filed: Nov. 9, 2023

(51) Int. Cl. H04L 1/00; H04L 27/26

(52) U.S. Cl. CPC H04L 1/0071; H04L 27/2614; H04L 27/2634

(57) ABSTRACT

In some implementations, a transmitter may transmit an indication of a frequency interleaver, from a set of frequency interleavers, that provides an interleaved sequence for a communication, the frequency interleaver being selected based on a peak-to-average power ratio (PAPR) of the interleaved sequence. The transmitter may transmit the communication including the interleaved sequence, and an index of the interleaved sequence being associated with an input signal that is interleaved via the frequency interleaver when the input signal is in a frequency domain.

### FIELD OF THE DISCLOSURE

Aspects of the present disclosure generally relate to wireless communication and to techniques and apparatuses for peak-to-average power ratio (PAPR) based frequency interleaving.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a transmitter for wireless communication. The transmitter may include one or more memories and one or more processors coupled to the one or more memories. The one or more processors may be configured to cause the transmitter to transmit an indication of a frequency interleaver, from a set of frequency interleavers, that provides an interleaved sequence for a communication, the frequency interleaver being selected based on a peak-to-average power ratio (PAPR) of the interleaved sequence. The one or more processors may be configured to cause the transmitter to transmit the communication including the interleaved sequence, and an index of the interleaved sequence being associated with an input signal that is interleaved via the frequency interleaver when the input signal is in a frequency domain.

Some aspects described herein relate to a receiver for wireless communication. The receiver may include one or more memories and one or more processors coupled to the one or more memories. The one or more processors may be configured to cause the receiver to receive an indication of a frequency interleaver, from a set of frequency interleavers, that provides an interleaved sequence for a communication, the frequency interleaver being selected based on a PAPR of the interleaved sequence. The one or more processors may be configured to cause the receiver to receive the communication including the interleaved sequence, and an index of the interleaved sequence being associated with an input signal that is interleaved via the frequency interleaver when the input signal is in a frequency domain.

Some aspects described herein relate to a method of wireless communication performed by a transmitter. The method may include transmitting an indication of a frequency interleaver, from a set of frequency interleavers, that provides an interleaved sequence for a communication, the frequency interleaver being selected based on a PAPR of the interleaved sequence. The method may include transmitting the communication including the interleaved sequence, and an index of the interleaved sequence being associated with an input signal that is interleaved via the frequency interleaver when the input signal is in a frequency domain.

Some aspects described herein relate to a method of wireless communication performed by a receiver. The method may include receiving an indication of a frequency interleaver, from a set of frequency interleavers, that provides an interleaved sequence for a communication, the frequency interleaver being selected based on a PAPR of the interleaved sequence. The method may include receiving the communication including the interleaved sequence, and an index of the interleaved sequence being associated with an input signal that is interleaved via the frequency interleaver when the input signal is in a frequency domain.

Some aspects described herein relate to a non-transitory computer-readable medium that stores a set of instructions for wireless communication by a transmitter. The set of instructions, when executed by one or more processors of the transmitter, may cause the transmitter to transmit an indication of a frequency interleaver, from a set of frequency interleavers, that provides an interleaved sequence for a communication, the frequency interleaver being selected based on a PAPR of the interleaved sequence. The set of instructions, when executed by one or more processors of the transmitter, may cause the transmitter to transmit the communication including the interleaved sequence, and an index of the interleaved sequence being associated with an input signal that is interleaved via the frequency interleaver when the input signal is in a frequency domain.

Some aspects described herein relate to a non-transitory computer-readable medium that stores a set of instructions for wireless communication by a receiver. The set of instructions, when executed by one or more processors of the receiver, may cause the receiver to receive an indication of a frequency interleaver, from a set of frequency interleavers, that provides an interleaved sequence for a communication, the frequency interleaver being selected based on a PAPR of the interleaved sequence. The set of instructions, when executed by one or more processors of the receiver, may cause the receiver to receive the communication including the interleaved sequence, and an index of the interleaved sequence being associated with an input signal that is interleaved via the frequency interleaver when the input signal is in a frequency domain.

Some aspects described herein relate to an apparatus for wireless communication. The apparatus may include means for transmitting an indication of a frequency interleaver, from a set of frequency interleavers, that provides an interleaved sequence for a communication, the frequency interleaver being selected based on a PAPR of the interleaved sequence. The apparatus may include means for transmitting the communication including the interleaved sequence, and an index of the interleaved sequence being associated with an input signal that is interleaved via the frequency interleaver when the input signal is in a frequency domain.

Some aspects described herein relate to an apparatus for wireless communication. The apparatus may include means for receiving an indication of a frequency interleaver, from a set of frequency interleavers, that provides an interleaved sequence for a communication, the frequency interleaver being selected based on a PAPR of the interleaved sequence. The apparatus may include means for receiving the communication including the interleaved sequence, an index of the interleaved sequence being associated with an input signal that is interleaved via the frequency interleaver when the input signal is in a frequency domain.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of power amplification, in accordance with the present disclosure.

FIGS. 5A and 5B are diagrams of an example associated with selective mapping for peak-to-average power ratio (PAPR) reduction, in accordance with the present disclosure.

FIG. 6 is a diagram of an example associated with PAPR-based frequency interleaving, in accordance with the present disclosure.

FIG. 7 is a diagram of an example associated with frequency interleaving, in accordance with the present disclosure.

FIG. 8 is a diagram of an example associated with PAPR-based frequency interleaving, in accordance with the present disclosure.

FIG. 9 is a diagram illustrating an example process performed, for example, at a transmitter or an apparatus of a transmitter, in accordance with the present disclosure.

FIG. 10 is a diagram illustrating an example process performed, for example, at a receiver or an apparatus of a receiver, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

In some examples, a transmitter may use a power amplifier to amplify a transmit power of a signal that is transmitted by the transmitter. A power amplifier may experience non-linear behavior at high input powers. For example, an output power of a power amplifier may have a linear relationship with low input powers, and a non-linear relationship with high input powers. This non-linear relationship may result in distortion (e.g., in-band distortion and/or out-of-band distortion) of a signal, as well as error vector magnitude (EVM) degradation at a receiver of the signal.

To avoid non-linearity in a power amplifier, the power amplifier may operate at a mean input power that is less than a saturation point The saturation point is an input power above which the input power and the output power have a non-linear relationship. In some cases, an input power used for a power amplifier may be correlated with a peak-to-average power ratio (PAPR) associated with a signal. For example, if a signal is associated with a PAPR of x decibels (dB), an input backoff (BO) from the saturation point may be x dB. In this way, peaks of the input power do not exceed the saturation point.

However, use of a BO may affect a performance of a power amplifier. If a BO is greater than a PAPR, a transmit power used by a transmitter may be overly restricted, and the transmitter may not transmit a signal with enough power to reach a receiver. If a BO is less than a PAPR, the transmitter's use of a greater transmit power may cause peaks of a signal to exceed the saturation point and result in distortion. If a BO is equal to a PAPR, the transmitter may use a maximum transmit power that does not cause distortion. However, in such examples, if the PAPR is large, then the maximum transmit power that does not cause distortion may be less power than is needed by a transmitter to reach a receiver (e.g., if the transmitter and the receiver are located far apart). Thus, it may be beneficial to reduce a PAPR by as much as possible, to thereby reduce a BO and increase a maximum transmit power that can be used by the transmitter. For example, operating near a saturation point of a power amplifier may achieve a maximum power efficiency, but may risk saturation of the transmitted signal. The saturation and/or clipping of the transmitted signal may distort the transmitted signal, thus generating output non-linearities, such as spectral growth and/or impact on a transmitted EVM (e.g., that should not exceed standard regulations), among other examples.

In some examples, wireless communication devices may communicate using orthogonal frequency division multiplexing (OFDM) signals. OFDM signals may be associated with a high PAPR. Moreover, a PAPR of OFDM signals may increase with a size of an OFDM block. Further, wireless communication systems associated with higher data rates (such as 5G/NR systems, 6G systems, and/or other systems) may use a larger OFDM block. An “OFDM block” may refer to a unit or segment of data that is processed using OFDM modulation. For example, because of the high PAPR associated with OFDM signals, peaks of the OFDM signals may be clipped by a power amplifier. This issue may be amplified for higher OFDM constellations, such as a 1024-quadrature amplitude modulation (QAM) constellation, among other examples. Due to the high PAPR of such signals, a large BO may be used in order to cause the transmitted signals to have improved EVM performance for high constellations, such as 1024-QAM and above. In some cases, PAPR reduction techniques may be used to reduce a PAPR associated with OFDM signals. However, current PAPR reduction techniques are data-dependent and consume significant processing resources. In some cases, a clipping and filtering technique may be used as an alternative to a PAPR reduction technique. However, a clipping and filtering technique may produce in-band distortion and other undesirable effects.

Various aspects described herein relate generally to PAPR-based frequency interleaving. Some aspects more specifically relate to a transmitter transmitting a signal using a frequency interleaver (from a set of frequency interleavers) that results in a lowest PAPR for an input signal. In some aspects, the transmitter may transmit, and a receiver may receive, an indication of a frequency interleaver, from a set of frequency interleavers, that provides an interleaved sequence for a communication, the frequency interleaver being selected based on a peak-to-average power ratio (PAPR) of the interleaved sequence.

For example, the transmitter may determine PAPRs of respective interleaved sequences of a set of interleaved sequences of the communication (e.g., where each interleaved sequence is associated with an input signal that is interleaved by a given frequency interleaver). The transmitter may select the interleaved sequence that is associated with the lowest PAPR. The transmitter may use the frequency interleaver associated with the selected interleaved sequence (e.g., that was used to generate the interleaved sequence) to transmit the communication to the receiver. For example, the transmitter may transmit, and the receiver may receive, the communication including the interleaved sequence, an index of the interleaved sequence being associated with an input signal that is interleaved via the frequency interleaver when the input signal is in a frequency domain (e.g., before an inverse fast Fourier transform (iFFT) operation is performed for the input signal).

For example, the input signal may be interleaved via the frequency interleaver prior to an iFFT operation. In some aspects, the transmitter may apply, for each interleaved sequence of the set of interleaved sequences, an iFFT to only portions of that interleaved sequence that have been interleaved. In some aspects, the frequency interleaver may cause resource elements and/or constellation symbols of different code blocks to be interleaved.

In some aspects, the transmitter and/or the receiver may transmit capability information indicating support for applying the set of frequency interleavers for the communication. For example, the capability information may indicate support for applying the set of frequency interleavers to the input signal to generate a signal for the communication.

Particular aspects of the subject matter described in this disclosure can be implemented to realize one or more of the following potential advantages. In some examples, the described techniques can be used to reduce a PAPR of OFDM signals transmitted by the transmitter. For example, by selecting a frequency interleaver that produces an interleaved sequence with a lowest PAPR (e.g., among a set of frequency interleavers), the transmitter may reduce the PAPR for the transmitted signal. By reducing the PAPR of the transmitted signal, the performance of a power amplifier of the transmitter may be improved (e.g., the transmitter may operate using an input power that is closer to the saturation point of the power amplifier with a reduced risk of exceeding the saturation point at peaks of the signal, thereby improving the efficiency of the power amplifier).

In some aspects, by using a selected frequency interleaver to reduce the PAPR of the transmitted signal, a complexity associated with reducing the PAPR may be reduced. For example, by applying, for each interleaved sequence of the set of interleaved sequences, an iFFT to only portions of that interleaved sequence that have been interleaved (e.g., and not to portions of that interleaved sequence that have not been interleaved or modified), a complexity of the iFFT operation may be reduced and/or the transmitter may conserve processing resources and/or power resources that would have otherwise been used to apply the iFFT to entire portions of each interleaved sequence of the set of interleaved sequences. Additionally, the selected frequency interleaver may be indicated to the receiver via signaling an index of the selected frequency interleaver, thereby conserving processing resources and/or network resources, among other examples, that would have otherwise been used to signal an indication of the entire frequency interleaver and/or sequence used to generate the signal (e.g., this may reduce a size of a communication that indicates the selected frequency interleaver).

Further, by using frequency interleaving to reduce the PAPR, the complexity of the PAPR reduction may be reduced and/or the transmitter may conserve processing resources and/or power resources that would have otherwise been used for more resource intensive PAPR reduction operations, such as scrambling. Moreover, by performing frequency interleaving across different code blocks, a performance of the transmitted signal may be improved because frequency domain diversity across the different code blocks may be improved, thereby improving the robustness of the transmitted signal to channel degradation that may have otherwise impacted one or more code blocks of the transmitted signal.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

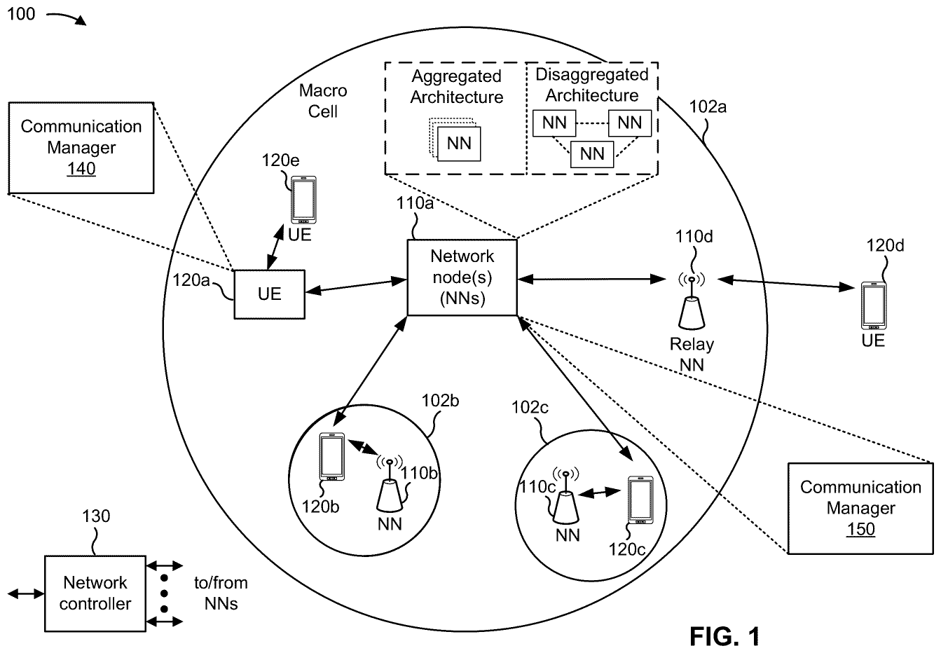

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit an indication of a frequency interleaver, from a set of frequency interleavers, that provides an interleaved sequence for a communication, the frequency interleaver being selected based on a PAPR of the interleaved sequence; and transmit the communication including the interleaved sequence, and an index of the interleaved sequence being associated with an input signal that is interleaved via the frequency interleaver when the input signal is in a frequency domain. Additionally, or alternatively, the communication manager 140 may receive an indication of a frequency interleaver, from a set of frequency interleavers, that provides an interleaved sequence for a communication, the frequency interleaver being selected based on a PAPR of the interleaved sequence; and receive the communication including the interleaved sequence, and an index of the interleaved sequence being associated with an input signal that is interleaved via the frequency interleaver when the input signal is in a frequency domain. Additionally, or alternatively, the communication manager 140 may perform one or more other operations described herein.

In some aspects, the network node 110 may include a communication manager 150. As described in more detail elsewhere herein, the communication manager 150 may receive an indication of a frequency interleaver, from a set of frequency interleavers, that provides an interleaved sequence for a communication, the frequency interleaver being selected based on a PAPR of the interleaved sequence; and receive the communication including the interleaved sequence, and an index of the interleaved sequence being associated with an input signal that is interleaved via the frequency interleaver when the input signal is in a frequency domain. Additionally, or alternatively, the communication manager 150 may transmit an indication of a frequency interleaver, from a set of frequency interleavers, that provides an interleaved sequence for a communication, the frequency interleaver being selected based on a PAPR of the interleaved sequence; and transmit the communication including the interleaved sequence, an index of the interleaved sequence being associated with an input signal that is interleaved via the frequency interleaver when the input signal is in a frequency domain. Additionally, or alternatively, the communication manager 150 may perform one or more other operations described herein.

As indicated above, FIG. 1 is provided as an example. Other examples may differ from what is described with regard to FIG. 1.

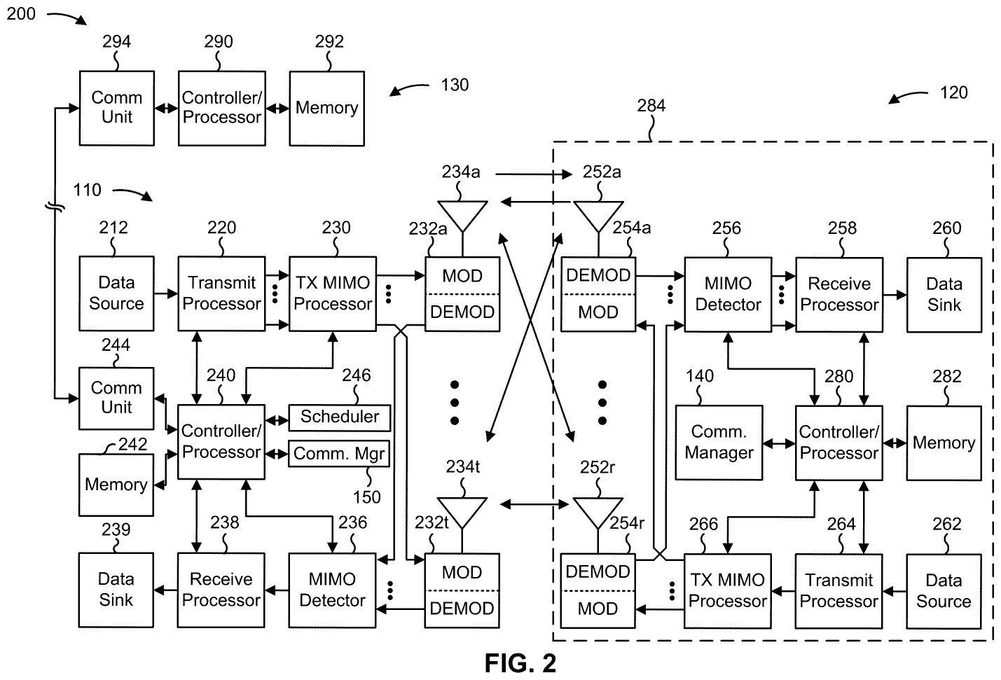

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

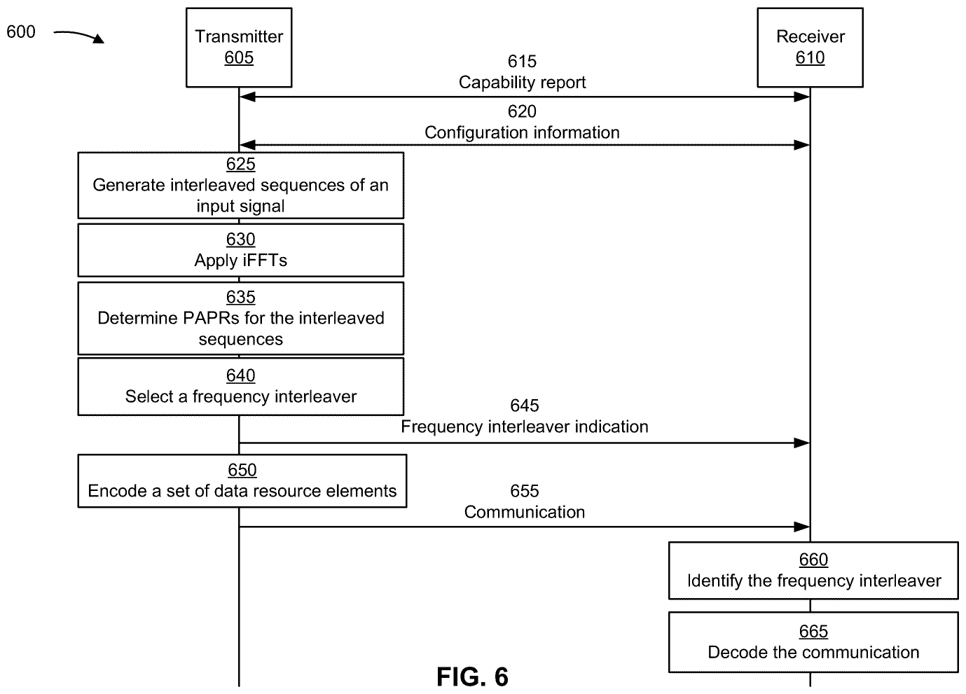

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-12).

The controller/processor 240 of the network node 110, the controller/processor 280 of the UE 120, and/or any other component(s) of FIG. 2 may perform one or more techniques associated with PAPR-based frequency interleaving, as described in more detail elsewhere herein. In some aspects, the transmitter described herein is the network node 110, is included in the network node 110, or includes one or more components of the network node 110 shown in FIG. 2. In some aspects, the transmitter described herein is the UE 120, is included in the UE 120, or includes one or more components of the UE 120 shown in FIG. 2. In some aspects, the receiver described herein is the network node 110, is included in the network node 110, or includes one or more components of the network node 110 shown in FIG. 2. In some aspects, the receiver described herein is the UE 120, is included in the UE 120, or includes one or more components of the UE 120 shown in FIG. 2.

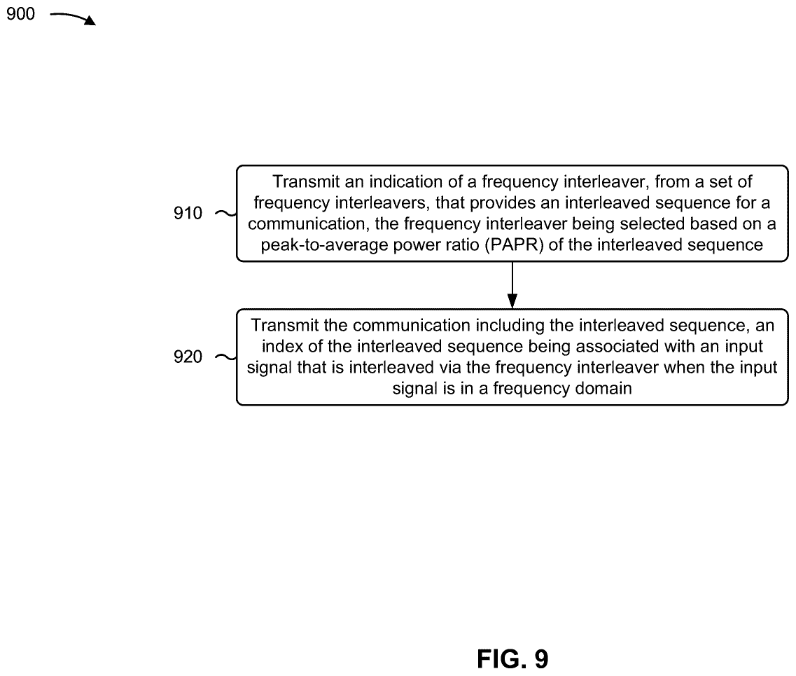

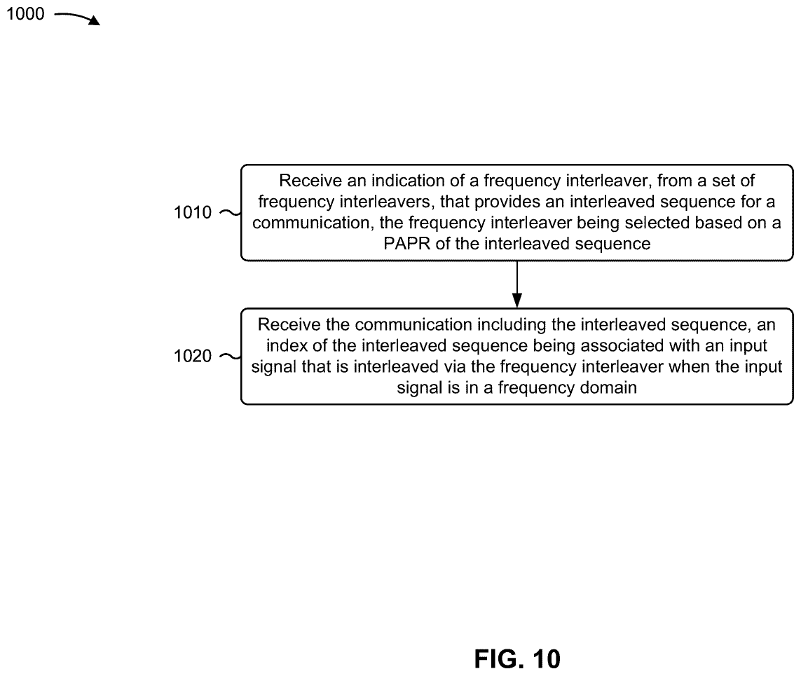

For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10. In some examples, executing instructions may include running the instructions, converting the instructions, compiling the instructions, and/or interpreting the instructions, among other examples.

In some aspects, a transmitter includes means for transmitting an indication of a frequency interleaver, from a set of frequency interleavers, that provides an interleaved sequence for a communication, the frequency interleaver being selected based on a peak-to-average power ratio (PAPR) of the interleaved sequence; and/or means for transmitting the communication including the interleaved sequence, an index of the interleaved sequence being associated with an input signal that is interleaved via the frequency interleaver when the input signal is in a frequency domain. In some aspects, the means for the transmitter to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some other aspects, the means for the transmitter to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a receiver includes means for receiving an indication of a frequency interleaver, from a set of frequency interleavers, that provides an interleaved sequence for a communication, the frequency interleaver being selected based on a PAPR of the interleaved sequence; and/or means for receiving the communication including the interleaved sequence, an index of the interleaved sequence being associated with an input signal that is interleaved via the frequency interleaver when the input signal is in a frequency domain. In some aspects, the means for the receiver to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some other aspects, the means for the receiver to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

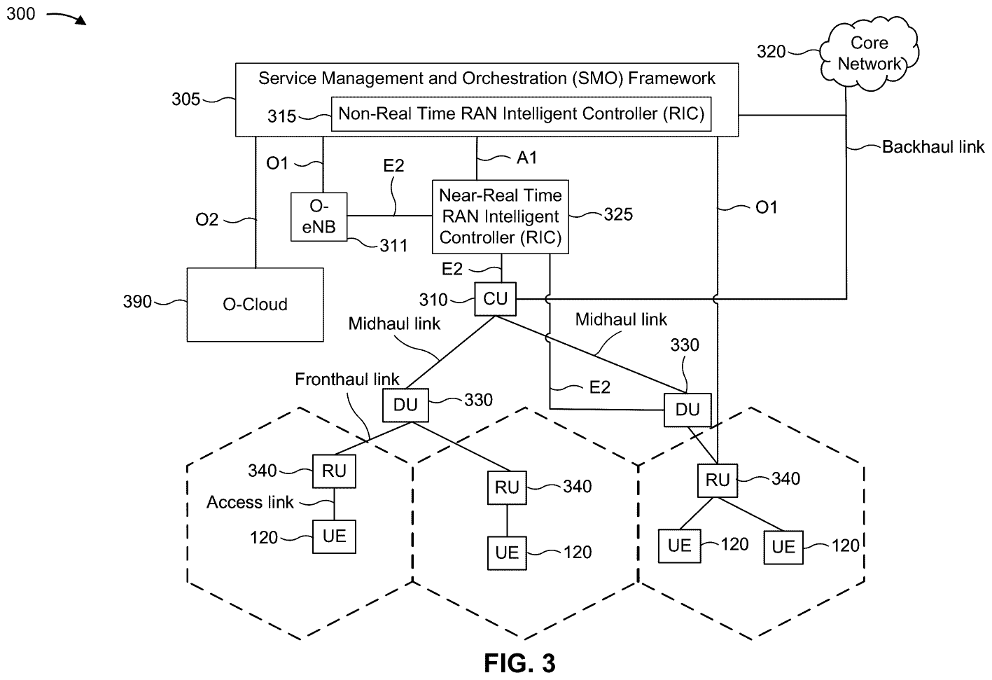

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an iFFT, digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

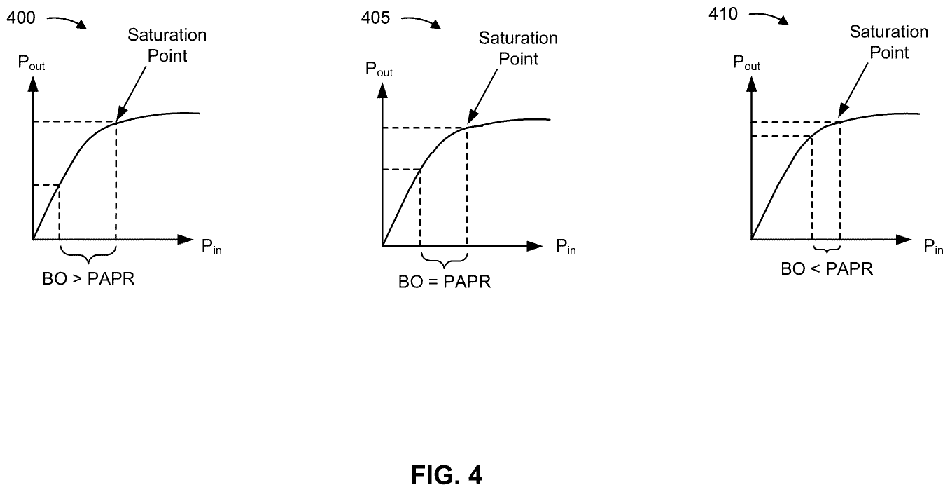

FIG. 4 is a diagram illustrating examples 400, 405, and 410 of power amplification, in accordance with the present disclosure.

A transmitter may use a power amplifier to amplify a transmit power of a signal that is transmitted by the transmitter. As shown in FIG. 4, a power amplifier may experience non-linear behavior at high input powers (Pᵢₙ). For example, an output power (Poₒᵤₜ) of a power amplifier may have a linear relationship with low input powers, and a non-linear relationship with high input powers. This non-linear relationship may result in distortion (e.g., in-band distortion and/or out-of-band distortion) of a signal, as well as EVM degradation at a receiver of the signal.

To avoid non-linearity in a power amplifier, the power amplifier may operate at a mean input power that is less than a saturation point (e.g., an input power above which the input power and the output power have a non-linear relationship). In some cases, an input power used for a power amplifier may be correlated with a PAPR associated with a signal. For example, if a signal is associated with a PAPR of x dB, an input BO from the saturation point may be x dB. In this way, peaks of the input power do not exceed the saturation point.

However, use of a BO may affect a performance of a power amplifier. As shown by example 400, if a BO is greater than a PAPR, a transmit power used by a transmitter may be overly restricted, and the transmitter may not transmit a signal with enough power to reach a receiver. As shown by example 410, if a BO is less than a PAPR, the transmitter's use of a greater transmit power may cause peaks of a signal to exceed the saturation point and result in distortion. As shown by example 405, if a BO is equal to a PAPR, the transmitter may use a maximum transmit power that does not cause distortion. However, in such examples, if the PAPR is large, then the maximum transmit power that does not cause distortion may be less power than is needed by a transmitter to reach a receiver (e.g., if the transmitter and the receiver are located far apart). Thus, it is beneficial to reduce a PAPR by as much as possible, to thereby reduce a BO and increase a maximum transmit power that can be used by the transmitter. For example, operating near a saturation point of a power amplifier may achieve a maximum power efficiency, but may risk saturation of the transmitted signal. The saturation and/or clipping of the transmitted signal may distort the transmitted signal, thus generating output non-linearities, such as spectral growth and/or impact on a transmitted EVM (e.g., that should not exceed standard regulations), among other examples.

In some examples, wireless communication devices may communicate using OFDM signals. OFDM signals may be associated with a high PAPR. Moreover, a PAPR of OFDM signals may increase with a size of an OFDM block. Further, wireless communication systems associated with higher data rates (such as 5G/NR systems, 6G systems, and/or other systems) may use a larger OFDM block. An “OFDM block” may refer to a unit or segment of data that is processed using OFDM modulation. For example, because of the high PAPR associated with OFDM signals, peaks of the OFDM signals may be clipped by a power amplifier. This issue may be amplified for higher OFDM constellations, such as a 1024-QAM constellation, among other examples. Due to the high PAPR of such signals, a large BO may be used in order to cause the transmitted signals to have good EVM performance for high constellations, such as 1024-QAM and above. In some cases, PAPR reduction techniques may be used to reduce a PAPR associated with OFDM signals. However, current PAPR reduction techniques are data-dependent and consume significant processing resources, and are therefore unsuitable for real-time implementation. In some cases, a clipping and filtering technique may be used as an alternative to a PAPR reduction technique. However, a clipping and filtering technique may produce in-band distortion and other undesirable effects.

As indicated above, FIG. 4 is provided as an example. Other examples may differ from what is described with respect to FIG. 4.

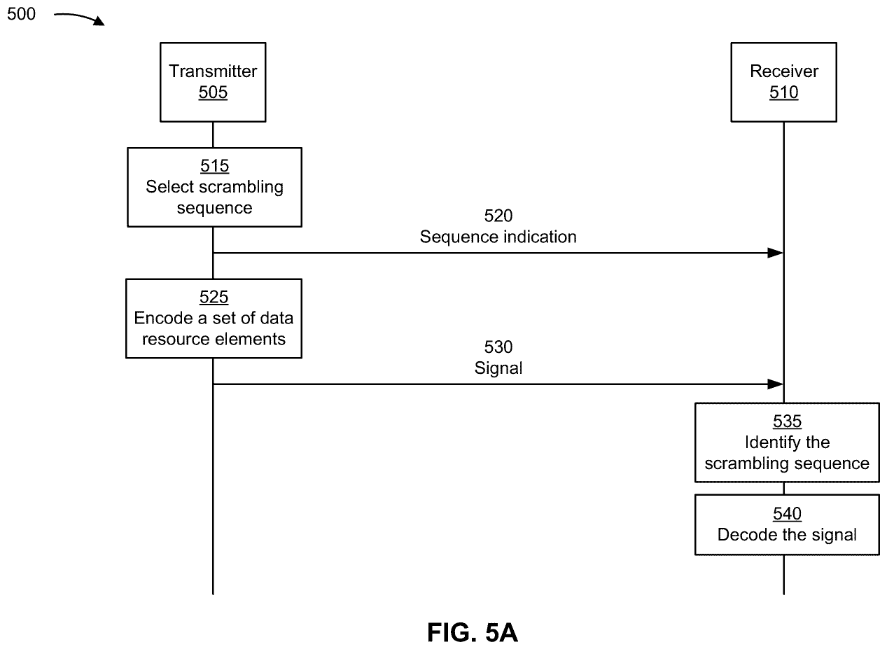

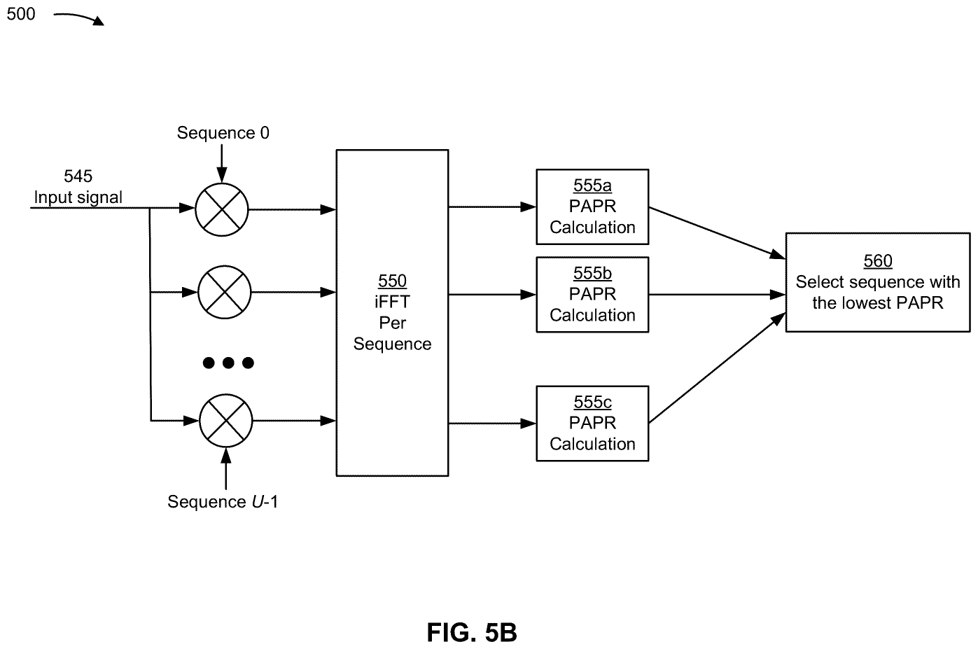

FIGS. 5A and 5B are diagrams of an example 500 associated with selective mapping for PAPR reduction, in accordance with the present disclosure. As shown in FIG. 5, a transmitter 505 (e.g., a UE 120, network node 110, a CU, a DU, and/or an RU) may communicate with a receiver 510 (e.g., a UE 120, network node 110, a CU, a DU, and/or an RU). In some aspects, the transmitter 505 and the receiver 510 may be part of a wireless network (e.g., the wireless network 100). The transmitter 505 and the receiver 510 may have established a wireless connection prior to operations shown in FIG. 5.

As used herein, “transmitter” may refer to a wireless communication device that is configured to transmit a signal in the context of a given example. For example, a transmitter may be configured to transmit and receive signals as described herein (e.g., a transmitter may not be configured to only transmit signals). Similarly, as used herein, “receiver” may refer to a wireless communication device that is configured to receive a signal in the context of a given example. For example, a receiver may be configured to transmit and receive signals as described herein (e.g., a receiver may not be configured to only receive signals). In other examples, the transmitter 505 may perform operations described herein in connection with the receiver 510, and the receiver 510 may perform operations described herein in connection with the transmitter 505.

The selective mapping for PAPR reduction may include the transmitter 505 selecting a scrambling sequence (e.g., from a pool of two or more scrambling sequences) to apply to each symbol period for a data transmission to the receiver 510. The scrambling sequence may be a numerical sequence, such as a Zadoff Chu sequence, a Gold sequence, a pseudo random sequence, and/or a low correlation sequence, among other examples, used to scramble or descramble/unscramble a transmission (e.g., by encoding a transmission using the scrambling sequence or, in the case of a receiver, decoding a scrambled transmission using the scrambling sequence). In some cases, the transmitter 505 may select a scrambling sequence to use for each symbol period to reduce mismatch between power amplifier (PA) modeling for a reference signal and corresponding data resource element, which may also reduce the variance in PAPR for each symbol period. In some cases, the transmitter 505 may select the scrambling sequence from a pool of scrambling sequences (e.g., a predetermined pool). The transmitter 505 may select the scrambling sequence based on modeling the PA and resulting PAPR for each symbol period (e.g., because the model may be different depending on the data in each symbol period). Additionally, or alternatively, the transmitter 505 may select the scrambling sequence based on a PAPR value, such as selecting a scrambling sequence that minimizes the PAPR value. For example, the transmitter 505 may perform the PA modeling and may scramble each symbol period of a data transmission according to a selected scrambling sequence.

As shown in FIG. 5A, and by reference number 515, the transmitter 505 may select the scrambling sequence from a pool or set of candidate scrambling sequences based on a value of a non-linearity parameter for a set of data resource elements for transmitting data in one or more symbol periods and a set of pilot resource elements for transmitting DMRSs for the data in the one or more symbol periods. In some examples, the transmitter 505 may determine the pool of candidate scrambling sequences based on a predetermined pool (e.g., there may be two candidate scrambling sequences for each symbol period), based on control signaling, or based on other means. The transmitter 505 may determine a non-linearity parameter from a PA model of the pilot resource elements, the data resource elements, or both. That is, the transmitter 505 may perform an estimation procedure for each symbol period (e.g., each OFDM symbol period) to evaluate the non-linearity parameter for each scrambling sequence from the pool of candidate scrambling sequences. Each symbol period may include one or more resource elements across a set of subcarriers. The resource elements may include resource elements for DMRSs (e.g., pilot resource elements) and resource elements for data (e.g., data resource elements). The resource elements may span one or more symbol periods. The transmitter 505 may identify the scrambling sequence based on performing the estimation procedure.

For example, the transmitter 505 may determine a PAPR for each scrambling sequence from the pool for a symbol period. The transmitter 505 may select the scrambling sequence based on comparing the calculated PAPRs for each scrambling sequence. In some cases, the transmitter 505 may select the scrambling sequence with a lowest PAPR value for the symbol period (e.g., for data resource elements, pilot resource elements, or both within the symbol period). In some examples, the transmitter 505 may select the scrambling sequence based on the PAPR value satisfying a threshold value.

As shown by reference number 520, the transmitter 505 may transmit a scrambling sequence indication to the receiver 510. The transmitter 505 may transmit control signaling including an indication of the selected scrambling sequence for each symbol period. For example, the transmitter 505 may include, in the control signaling, a one bit indicator indicating a scrambling sequence for each symbol period (e.g., on a per symbol basis or a per slot basis) or indicating a baseline distribution with no scrambling control. In some other examples, the receiver 510 may blindly estimate the scrambling sequence by measuring frequency coherency of an estimated channel. In such examples, the transmitter 505 may not transmit the scrambling sequence indication.

The transmitter 505 may include the scrambling sequence indication in control signaling, such as downlink control information (DCI), uplink control information (UCI), and/or one or more MAC control elements (MAC-CEs), among other examples. For example, the transmitter 505 may transmit a DCI message to the receiver 510, the DCI message including one or more bits indicating the scrambling sequence (e.g., where the receiver 510 is a UE). In some other examples, the receiver 510 may transmit a UCI message to the receiver 510, the UCI message including one or more bits indicating the scrambling sequence (e.g., where the transmitter 505 is a UE).

As shown by reference number 525, the transmitter 505 may encode the data for the set of data resource elements according to the scrambling sequence. In some examples, a PAPR for the data from each of the one or more symbol periods encoded according to the first scrambling sequence may satisfy a threshold value or may be a minimum value for the PAPR among a set of PAPRs. As shown by reference number 530, the transmitter 505 may transmit the set of data resource elements with the set of pilot resource elements to the receiver 510 in the one or more symbol periods.

As shown by reference number 535, the receiver 510 may identify the scrambling sequence used by the transmitter 505 to scramble the data. For example, the receiver 510 may identify the scrambling sequence based on the scrambling sequence indication or based on blindly estimating the scrambling sequence.

In some examples, the receiver 510 may perform a measurement of a channel for the set of data resource elements or based on one or more pilot resources (e.g., if the transmitter 505 applies the same scrambling sequence to the pilot resources) and may blindly estimate the scrambling sequence based on the measurement of the channel. In some examples, performing the channel measurement for the pilot resources may enable the receiver 510 to better estimate the scrambling sequence. The receiver 510 may identify incorrect scrambling sequences based on if there is a relatively large, or non-realistic, delay spread estimation or a relatively low frequency coherency. As shown by reference number 540, the receiver 510 may decode the signal using the identified scrambling sequence.

For example, as shown in FIG. 5B, the selective mapping for PAPR reduction may include the transmitter 505 multiplying an input signal with a set of U sequences (e.g., scrambling sequences) and then selecting and transmitting an overall signal that exhibits the lowest PAPR. Because the PAPR is determined by the scrambling sequence of the transmitted signal, by multiplying the signal by a random phase may change the PAPR properties after an iFFT operation. For example, the selection operation (described in connection with reference number 515) may include the transmitter 505 multiplying an input signal 545 by the set of U sequences (e.g., sequence 0 to sequence U−1). The sequence 0 may result in an unscrambled signal (e.g., an output of the multiplication of the sequence 0 by the input signal 545 may result in the input signal 545). For example, the sequence 0 may be all values of 1. The input signal 545 may include a set of data bits or a set of constellation symbols.

As shown by reference number 550, the transmitter 505 may perform an iFFT operation for each sequence (e.g., for each scrambled signal, where a scrambled signal includes the input signal 545 multiplied by (e.g., scrambled by) a given sequence). The transmitter 505 may determine (e.g., calculate) a PAPR for each scrambled signal (e.g., as shown by reference number 555a, reference number 555b, and reference number 555c). A determination of a PAPR for a given signal may include determining, in the time domain, a sample (e.g., an in-phase/quadrature (I/Q) sample) of the given signal with a highest amplitude. The power of the identified sample may represent the peak power of the given signal. The transmitter 505 may determine an average power of the given signal according to:

$${P}_{a v g} = \frac{1}{N} {\sum }_{n = 0}^{N - 1} {\vert x ( n ) \vert}^{2} ,$$

where P_{avg} is the average power, N is a total number of samples of the given signal, and x(n) is the sample values (e.g., power values) of the given signal. The transmitter 505 may determine the PAPR for the given signal according to:

$$P A P R = \frac{{P}_{P e a k}}{{P}_{a v g}} ,$$

where P_{Peak} is the peak power of the given signal. The resulting PAPR value may be a dimensionless ratio that indicates how much the peak power of the given signal exceeds the average power of the given signal. As described elsewhere herein, higher PAPR values may indicate a larger difference between peak and average power, which can result in challenges for power amplifiers and lead to potential signal clipping. As shown by reference number 560, the transmitter 505 may select a sequence that is associated with a lowest PAPR value (e.g., may select the sequence that is associated with a scrambled signal having the lowest PAPR value). The selective mapping may result in a reduced PAPR for the transmitted signal (e.g., the signal transmitted as described in connection with reference number 530). However, performing the selective mapping may be complex and consume processing resources of the transmitter 505.

Various aspects described herein relate generally to PAPR-based frequency interleaving. Some aspects more specifically relate to a transmitter transmitting a signal using a frequency interleaver (from a set of frequency interleavers) that results in a lowest PAPR for an input signal. In some aspects, the transmitter may transmit, and a receiver may receive, an indication of a frequency interleaver, from a set of frequency interleavers, that provides an interleaved sequence for a communication, the frequency interleaver being selected based on a peak-to-average power ratio (PAPR) of the interleaved sequence.

For example, the transmitter may determine PAPRs of respective interleaved sequences of a set of interleaved sequences of the communication (e.g., where each interleaved sequence is associated with an input signal that is interleaved by a given frequency interleaver). The transmitter may select the interleaved sequence that is associated with the lowest PAPR. The transmitter may use the frequency interleaver associated with the selected interleaved sequence (e.g., that was used to generate the interleaved sequence) to transmit the communication to the receiver. For example, the transmitter may transmit, and the receiver may receive, the communication including the interleaved sequence, an index of the interleaved sequence being associated with an input signal that is interleaved via the frequency interleaver when the input signal is in a frequency domain (e.g., before an iFFT operation is performed for the input signal).

For example, the input signal may be interleaved via the frequency interleaver prior to an iFFT operation. In some aspects, the transmitter may apply, for each interleaved sequence of the set of interleaved sequences, an iFFT to only portions of that interleaved sequence that have been interleaved. In some aspects, the frequency interleaver may cause resource elements and/or constellation symbols of different code blocks to be interleaved.

In some aspects, the transmitter and/or the receiver may transmit capability information indicating support for applying the set of frequency interleavers for the communication. For example, the capability information may indicate support for applying the set of frequency interleavers to the input signal to generate a signal for the communication.

Particular aspects of the subject matter described in this disclosure can be implemented to realize one or more of the following potential advantages. In some examples, the described techniques can be used to reduce a PAPR of OFDM signals transmitted by the transmitter. For example, by selecting a frequency interleaver that produces an interleaved sequence with a lowest PAPR (e.g., among a set of frequency interleavers), the transmitter may reduce the PAPR for the transmitted signal. By reducing the PAPR of the transmitted signal, the performance of a power amplifier of the transmitter may be improved (e.g., the transmitter may operate using an input power that is closer to the saturation point of the power amplifier with a reduced risk of exceeding the saturation point at peaks of the signal, thereby improving the efficiency of the power amplifier).

In some aspects, by using a selected frequency interleaver to reduce the PAPR of the transmitted signal, a complexity associated with reducing the PAPR may be reduced. For example, by applying, for each interleaved sequence of the set of interleaved sequences, an iFFT to only portions of that interleaved sequence that have been interleaved (e.g., and not to portions of that interleaved sequence that have not been interleaved or modified), a complexity of the iFFT operation may be reduced and/or the transmitter may conserve processing resources and/or power resources that would have otherwise been used to apply the iFFT to entire portions of each interleaved sequence of the set of interleaved sequences. Additionally, the selected frequency interleaver may be indicated to the receiver via signaling an index of the selected frequency interleaver, thereby conserving processing resources and/or network resources, among other examples, that would have otherwise been used to signal an indication of the entire frequency interleaver and/or sequence used to generate the signal (e.g., this may reduce a size of a communication that indicates the selected frequency interleaver).

Further, by using frequency interleaving to reduce the PAPR, the complexity of the PAPR reduction may be reduced and/or the transmitter may conserve processing resources and/or power resources that would have otherwise been used for more resource intensive PAPR reduction operations, such as scrambling. Moreover, by performing frequency interleaving across different code blocks, a performance of the transmitted signal may be improved because frequency domain diversity across the different code blocks may be improved, thereby improving the robustness of the transmitted signal to channel degradation that may have otherwise impacted one or more code blocks of the transmitted signal.

As indicated above, FIG. 5 is provided as an example. Other examples may differ from what is described with respect to FIG. 5.

FIG. 6 is a diagram of an example 600 associated with PAPR-based frequency interleaving, in accordance with the present disclosure. As shown in FIG. 6, a transmitter 605 (e.g., a UE 120, network node 110, a CU, a DU, and/or an RU) may communicate with a receiver 610 (e.g., a UE 120, network node 110, a CU, a DU, and/or an RU). In some aspects, the transmitter 605 and the receiver 610 may be part of a wireless network (e.g., the wireless network 100). The transmitter 605 and the receiver 610 may have established a wireless connection prior to operations shown in FIG. 6. In some other aspects, the transmitter 605 may perform operations described herein in connection with the receiver 610 and the receiver 610 may perform operations described herein in connection with the transmitter 605, such as when the receiver 610 is transmitting one or more signals to the transmitter 605.

In some aspects, as shown by reference number 615, the transmitter 605 and the receiver 610 may communicate (e.g., transmit and/or receive) capability information. In some aspects, the transmitter 605 may transmit, and the receiver 610 may receive, a capability report. Additionally, or alternatively, the receiver 610 may transmit, and the transmitter 605 may receive, a capability report.

The transmitter 605 and/or the receiver 610 may communicate (e.g., transmit and/or receive) the capability report via an uplink communication, a downlink communication, a sidelink communication, a UE assistance information (UAI) communication, a UCI communication, a MAC-CE communication, an RRC communication, a physical uplink control channel (PUCCH), and/or a physical uplink shared channel (PUSCH), among other examples. For example, the capability information may be associated with radio resource control signaling, uplink control information signaling, or downlink control information signaling. A capability report may indicate one or more parameters associated with respective capabilities of the transmitter 605 and/or the receiver 610. The one or more parameters may be indicated via respective information elements (IEs) included in the capability report.

The capability report may indicate whether the transmitter 605 and/or the receiver 610 supports a feature and/or one or more parameters related to the feature. For example, the capability report may indicate a capability and/or parameter for PAPR-based frequency interleaving. As another example, the capability report may indicate a capability and/or parameter for applying a set of frequency interleavers for one or more communications. One or more operations described herein may be based on capability information of the capabilities report. For example, the transmitter 605 and/or the receiver 610 may perform a communication in accordance with the capability information, or may receive configuration information that is in accordance with the capability information.

In some aspects, the capability report may indicate support for applying a set of frequency interleavers for one or more communications. In some aspects, the capability report may indicate whether the receiver supports receiving a communication in association with applying a set of frequency interleavers (e.g., supports deinterleaving a communication using a given frequency interleaver). Additionally, or alternatively, a capability report may indicate support for the transmitter 605 applying a set of frequency interleavers to the input signal to generate a signal for the communication (e.g., and selecting a given frequency interleaver based on PAPR values of the generated signal). For example, the capability report may indicate whether the transmitter 605 supports generating a set of interleaved sequences using an input signal and respective frequency interleavers from a set of frequency interleavers. The capability report may indicate whether the transmitter 605 supports selecting a frequency interleaver, from the set of frequency interleavers, based on an interleaved sequence generated via the frequency interleaver having a lowest PAPR among the set of interleaved sequences.

As shown by reference number 620, the transmitter 605 and the receiver 610 may communicate (e.g., transmit and/or receive) configuration information. In some aspects, the transmitter 605 may transmit, and the receiver 610 may receive, the configuration information (e.g., when the transmitter 605 is a network node 110 or a control entity). Additionally, or alternatively, the receiver 610 may transmit, and the transmitter 605 may receive, the configuration information (e.g., when the receiver 610 is a network node 110 or a control entity). In some other aspects, the transmitter 605 and the receiver 610 may receive the configuration from another device, such as a control entity (e.g., a network node 110, a CU, or a DU). In some aspects, the configuration information may be communicated via one or more of system information (e.g., a master information block (MIB) and/or a system information block (SIB), among other examples), RRC signaling, MAC signaling (e.g., one or more MAC-CEs), sidelink control signaling, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the transmitter 605 is to generate a set of interleaved sequences using an input signal and respective frequency interleavers from a set of frequency interleavers. The configuration information may indicate that the transmitter 605 is to select a frequency interleaver, from the set of frequency interleavers, based on an interleaved sequence generated via the frequency interleaver having a lowest PAPR among the set of interleaved sequences. In some aspects, the configuration information may indicate that the transmitter 605 is to transmit, and the receiver 610 is to receive, an indication of a frequency interleaver (e.g., via MAC signaling or DCI signaling), from a set of frequency interleavers, that provides an interleaved sequence for a communication, the frequency interleaver being selected based on a peak-to-average power ratio (PAPR) of the interleaved sequence. In some aspects, the configuration information may indicate an element of an input signal to be interleaved. For example, the element may include one or more bits, one or more resource elements, and/or one or more constellation symbols, among other examples.

In some aspects, the configuration information may indicate a set of frequency interleavers. As used herein, an “interleaver” or a “frequency interleaver” may be a sequence or vector indicating frequency domain elements of a signal that are to be swapped or interleaved. For example, a frequency interleaver may indicate that an element N and an element N+1 are to be swapped, and/or an element N+2 and an element N+5 are to be swapped, among other examples. For example, the transmitter 605 may transmit, and the receiver 610 may receive, an indication of the set of frequency interleavers. Alternatively, the receiver 610 may transmit, and the transmitter 605 may receive, an indication of the set of frequency interleavers. The indication of the set of interleavers may be communicated via radio resource control signaling, uplink control information signaling, MAC signaling, and/or downlink control information signaling.

In some aspects, the indication of the set of frequency interleavers may include an indication of M frequency interleavers from a set of L frequency interleavers (e.g., where M is less than or equal to L). For example, an RRC configuration or another configuration may configure the set of L frequency interleavers. Additionally, or alternatively, the set of L frequency interleavers may be defined, or otherwise fixed, by a wireless communication standard, such as the 3GPP. The indication of the set of frequency interleavers (e.g., the M frequency interleavers) may indicate a subset of the configured or defined set of L frequency interleavers. For example, the indication of the M frequency interleavers may be communicated via RRC signaling, MAC signaling (e.g., one or more MAC-CEs), DCI signaling, or UCI signaling, among other examples.

In some aspects, the configuration information may indicate one or more different types of frequency interleavers that are available to be used for communications between the transmitter 605 and the receiver 610. For example, the configuration information may define a set of frequency interleavers, P. The set of frequency interleavers may include different subsets of interleavers with different sizes (e.g., to support different PAPR conditions). A “size” or “length” of a frequency interleaver may refer to a quantity of elements interleaved via the frequency interleaver. For example, the set of frequency interleavers may include {P2_1, P2_2, P4_1, P16_1, P16_2, P16_3}, where P2 includes two interleavers and the length of each subset of interleavers may be different to support various PAPR reduction options (P2_1 vs P2_2 may have different lengths or sizes).

In some aspects, the capability information described in connection with reference number 615 and/or the configuration information described in connection with reference number 620 may include information transmitted via multiple communications. Additionally, or alternatively, the configuration information, or a communication including at least a portion of the configuration information, may be transmitted before and/or after a transmission of the capability information. For example, a first device (e.g., the transmitter 605 or the receiver 610) may transmit a first portion of the configuration information before a second device (e.g., the transmitter 605 or the receiver 610) transmits the capability information, the second device may transmit at least a portion of the capability information, and the first device may transmit a second portion of the configuration information after receiving the capability information.

The transmitter 605 and/or the receiver 610 may configure itself based at least in part on the configuration information. In some aspects, the transmitter 605 and/or the receiver 610 may be configured to perform one or more operations described herein based at least in part on the configuration information. For example, the transmitter 605 and/or the receiver 610 may configure the set of frequency interleavers for PAPR reduction operations described herein.

As shown by reference number 625, the transmitter 605 may generate interleaved sequences of an input signal. For example, the transmitter 605 may use the input signal and the set of frequency interleavers to generate respective interleaved sequences. The input signal may include one or more bits, one or more resource elements, and/or one or more constellation symbols (e.g., QAM symbols), among other examples. The input signal may be a data signal (e.g., may include data, X=[X₀, X₁, . . . X_{N-1}], where the data include N elements). The N elements may be N bits (e.g., the interleaving may be performed prior to mapping the N bits to resource elements or prior to modulation), N resource elements, or N constellation symbols. For example, the transmitter 605 may perform bit/constellation symbol/resource element based data input interleaving. In other words, the input signal may be in the bit domain, the resource element domain, or the constellation symbol domain, among other examples. The transmitter 605 may generate the interleaved sequence while input signal is in the frequency domain. In other words, the input signal may be interleaved via the frequency interleavers when the input signal is in the frequency domain (e.g., before an iFFT is applied to the input signal). For example, the input signal may be interleaved via a frequency interleaver prior to an iFFT operation.

In some aspects, a frequency interleaver may indicate that element index 0 and element index N−1 are to be swapped. In such examples, an interleaved sequence of the input signal may be X₁=[X_{N-1}, X₁, . . . , X₀]. As another example, a frequency interleaver may indicate that element index 1 and element index N−1 are to be swapped. In such examples, an interleaved sequence of the input signal may be X₂=[X₀, X_{N-1}, . . . , X₁]. In some aspects, a frequency interleaver may define an order in which the transmitter 605 is to read or obtain data from memory (e.g., from a buffer). For example, the transmitter 605 may perform frequency interleaving by reading the data of the input signal from the memory in a different order (e.g., as defined by one or more frequency interleavers). As a result, the frequency interleaving may be associated with relatively less complexity and a lower processing overhead than other PAPR reduction techniques, such as scrambling.

As shown by reference number 630, the transmitter 605 may apply iFFTs to the interleaved sequences of the input signal. For example, the transmitter 605 may perform iFFT operations for respective interleaved sequences. An iFFT operation may convert a signal from the frequency domain to the time domain (e.g., an iFFT may reconstruct a time domain signal from a frequency domain representation of the time domain signal). In other words, by interleaving the input signal prior to performing the iFFT operation(s), the input signal may be interleaved in the frequency domain. In some aspects, the transmitter 605 may perform an iFFT operation for each interleaved sequence of the input signal.

In some aspects, the input signal may be an input to an iFFT component associated with generating a signal for a communication. For example, each interleaved sequence of the input signal may be input to the iFFT component. In some aspects, the transmitter 605 may apply, for each interleaved sequence of the set of interleaved sequences, an iFFT to only portions of that interleaved sequence that have been interleaved. In other words, the transmitter 605 may perform an iFFT operation of the input signal (e.g., may perform an iFFT operation using a non-interleaved version of the input signal). For each interleaved sequence, the transmitter 605 may perform an iFFT operation for interleaved portions of that interleaved sequence (e.g., rather than the entire interleaved sequence). The transmitter 605 may obtain an interleaved signal (e.g., time domain signal) for each interleaved sequence by combining the output of the iFFT for that interleaved sequence and the output of the iFFT for the input signal (e.g., the output of the iFFT for the non-interleaved version of the input signal). As a result, a complexity associated with the iFFT operation may be reduced. Additionally, the transmitter 605 may conserve processing resources, and/or power resources, among other examples, that would have otherwise been associated with performing an iFFT operation of the entire interleaved sequence for each interleaved sequence.

As shown by reference number 635, the transmitter 605 may determine PAPRs for the interleaved sequences. For example, the transmitter 605 may determine PAPRs for respective signals associated with the interleaved sequences. For example, the output of the iFFT operation may be an interleaved signal (e.g., corresponding to a given interleaved sequence). The transmitter 605 may determine a PAPR for each interleaved signal.

As shown by reference number 640, the transmitter 605 may select a frequency interleaver (e.g., for a communication). For example, the transmitter 605 may select the frequency interleaver based on the PAPRs. For example, the transmitter 605 may determine a lowest PAPR among the determined (e.g., calculated) PAPRs. The transmitter 605 may identify an interleaved signal that is associated with the lowest PAPR. The transmitter 605 may identify a frequency interleaver associated with the interleaved signal that is associated with the lowest PAPR. The frequency interleaver may be associated with the interleaved signal in that the frequency interleaver was used to generate the interleaved signal. For example, the transmitter 605 may select the frequency interleaver from the set of frequency interleavers in association with the PAPR being a lowest PAPR among PAPRs associated with respective interleaved sequences of the set of interleaved sequences. In other words, the PAPR-based frequency interleaving described herein enables the transmitter 605 to select (e.g., out of a set of frequency interleavers P) an interleaved sequence that provided the lowest PAPR.

In some aspects, if two or more frequency interleavers result in interleaved signals having the same PAPR, the transmitter 605 may select a frequency interleaver, from the two or more frequency interleavers, based on the sizes or lengths of the frequency interleavers. For example, the transmitter 605 may select a frequency interleaver, from the two or more frequency interleavers, having the smallest size or shortest length (e.g., because the smaller or shorter frequency interleaver may be associated with less complexity and/or less processing overhead). Additionally, or alternatively, the transmitter 605 may select a frequency interleaver, from the two or more frequency interleavers, based on the indices of the two or more frequency interleavers. For example, the transmitter 605 may select the frequency interleaver associated with a lowest index. As another example, the transmitter 605 may select a frequency interleaver, from the two or more frequency interleavers, having the larger size or longer length (e.g., because the larger frequency interleaver may interleave more elements of the signal, increasing the frequency domain diversity and the performance of the signal). As another example, the transmitter 605 may select a frequency interleaver, from the two or more frequency interleavers, based on block error rates (BLERs) associated with respective frequency interleavers from the two or more frequency interleavers (e.g., may select the frequency interleaver that results in a smallest BLER). As another example, the transmitter 605 may select a frequency interleaver, from the two or more frequency interleavers, based on hybrid automatic repeat request (HARQ) feedback associated with respective frequency interleavers from the two or more frequency interleavers (e.g., may select the frequency interleaver that results ACK feedback).

As shown by reference number 645, the transmitter 605 may transmit, and the receiver 610 may receive, a frequency interleaver indication. The frequency interleaver indication may indicate the selected frequency interleaver (e.g., from the set of configured or defined frequency interleavers). In some aspects, the frequency interleaver indication may include an index or other identifier of the selected frequency interleaver (e.g., rather than signaling the actual or whole frequency interleaver, thereby reducing a size of the frequency interleaver indication). For example, the transmitter 605 may transmit, and the receiver 610 may receive, an indication of a frequency interleaver, from the set of frequency interleavers, that provides an interleaved sequence for a communication. As described elsewhere herein, the frequency interleaver may be selected in association with a PAPR of an interleaved sequence, of the communication, that is interleaved via the frequency interleaver (e.g., based on the PAPR being a lowest produced PAPR for an input signal of the communication).

The transmitter 605 may transmit, and the receiver 610 may receive, the frequency interleaver indication via RRC signaling, MAC signaling (e.g., one or more MAC-CEs), DCI signaling, and/or UCI signaling, among other examples. In some aspects, the frequency interleaver indication may be included in scheduling information for the communication. For example, DCI that schedules that communication may include the frequency interleaver indication.

In some aspects, the indication of the frequency interleaver (e.g., the frequency interleaver indication) may indicate that the frequency interleaver is to be applied for a time interval. For example, the time interval may include a slot, a subframe, and/or one or more OFDM symbols (e.g., a single OFDM symbol or a span of multiple OFDM symbols), among other examples. For example, the transmitter 605 may transmit a frequency interleaver indication per slot (e.g., indicating a frequency interleaver to be applied in a given slot) or per symbol (e.g., indicating a frequency interleaver to be applied in one or more OFDM symbols). For example, the transmitter 605 may be configured to perform per-slot and/or per-OFDM symbol signaling (e.g., signaling of an index of a selected frequency interleaver).

The receiver 610 may configure itself to use the indicated frequency interleaver (e.g., to deinterleave and/or decode signals from the transmitter 605) based on receiving the frequency interleaver indication. For example, the receiver 610 may configure itself to use the indicated frequency interleaver for a time interval (e.g., a slot, a subframe, or one or more OFDM symbols).

As shown by reference number 650, the transmitter 605 may encode a set of data resource elements for the communication. For example, the transmitter 605 may encode an interleaved signal associated with the selected frequency interleaver for a communication. As shown by reference number 655, the transmitter 605 may transmit, and the receiver 610 may receive, a communication. The communication may be transmitted via an interleaved signal (e.g., that is interleaved via the selected frequency interleaver). The communication may be a downlink communication. Alternatively, the communication may be an uplink communication. Alternatively, the communication may be a sidelink communication.

As shown by reference number 660, the receiver 610 may identify the frequency interleaver. For example, the transmitter 605 may indicate an index of the frequency interleaver to the receiver 610 (e.g., via the frequency interleaver indication). The receiver 610 may identify the frequency interleaver to be used to deinterleave the interleaved signal based on the signaled index.

As shown by reference number 665, the receiver 610 may decode the communication. For example, the receiver 610 may apply, to the interleaved signal associated with the communication, an FFT to transform the signal to the frequency domain. The receiver 610 may deinterleave, in accordance with the indicated frequency interleaver, the interleaved signal in the frequency domain (e.g., to obtain the input signal). In some aspects, the receiver 610 may deinterleave the interleaved signal prior to performing a log-likelihood ratio (LLR) generation operation. The receiver 610 may obtain data indicated by the input signal based on deinterleaving the received signal from the transmitter 605 using the indicated frequency interleaver.

As indicated above, FIG. 6 is provided as an example. Other examples may differ from what is described with respect to FIG. 6.

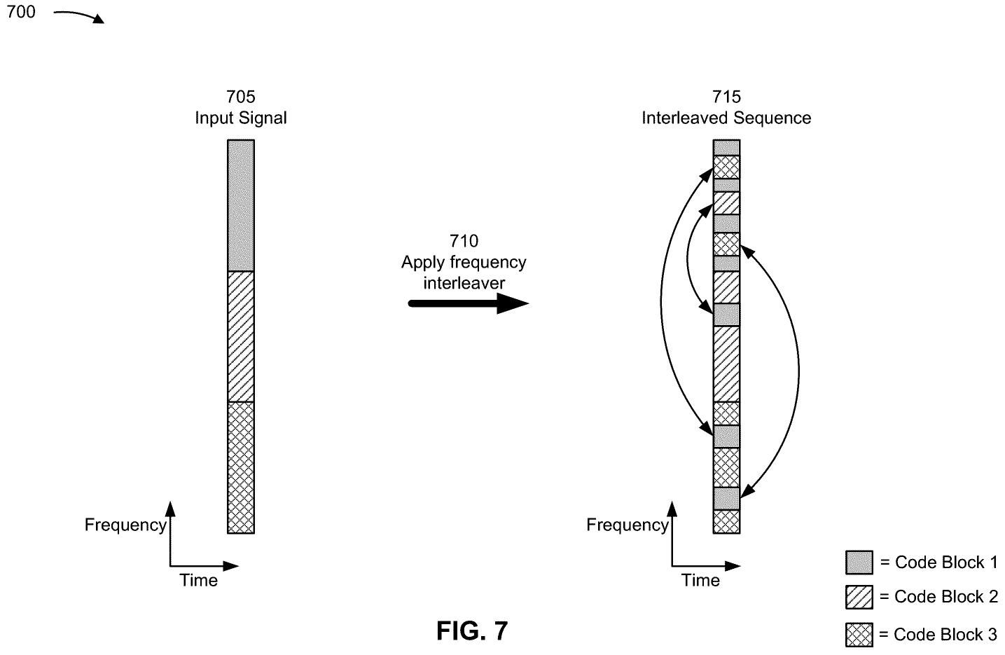

FIG. 7 is a diagram of an example 700 associated with frequency interleaving, in accordance with the present disclosure. The frequency interleaving operation described in connection with FIG. 7 may be performed by a transmitter described herein, such as the transmitter 605. For example, the frequency interleaving operation described in connection with FIG. 7 may be performed by the transmitter 605 as described in connection with reference number 625.

As shown in FIG. 7, the transmitter may obtain an input signal 705. The input signal 705 may include one or more code blocks (shown as three code blocks (code block 1, code block 2, and code block 3) in FIG. 7). A “code block” may refer to a block of digital information to be transmitted prior to adding a cyclic redundancy check (CRC) and/or performing channel coding. For example, a transport block (TB) may be divided or segmented into a set of one or more code blocks. A CRC may be added to the end of each code block. A receiver may attempt to decode each code block (or a code block group that includes one or more code blocks). The receiver may provide feedback (e.g., hybrid automatic repeat request (HARQ) feedback) on a code block basis, a code block group basis, or a TB basis.

As shown in FIG. 7, the transmitter may apply a frequency interleaver 710 to generate an interleaved sequence 715. As shown, the frequency interleaver 710 may interleave elements (e.g., bits, resource elements, or constellation symbols) across different code blocks. For example, an element associated with code block 1 (e.g., in the input signal 705) may be swapped with an element associated with the code block 2 or the code block 3. As a result, the element associated with code block 1 may be located, in the frequency domain, in a location that is associated with the code block 2 or the code block 3 (e.g., in the input signal 705). For example, the frequency interleaver 710 may interleave bits, resource elements, and/or constellation symbols to realize a frequency domain diversity gain across multiple code blocks. This may enable improved protection in the code block level for decoding. For example, there may be a channel imperfection (e.g., poor channel quality) or issue in the frequency domain range typically associated with the code block 3 (e.g., as indicated by the location of the code block 3 in the input signal 705). Because of the frequency interleaving across code blocks, some of the data associated with the code block 3 may be located, in the frequency domain, in the frequency domain range typically associated with the code block 1 and/or code block 2. As a result, this data may not be impacted by the channel imperfection or issue, thereby increasing a likelihood that the receiver is able to successfully receive that data. As a result, a likelihood that the receiver is able to successfully receive and decode the code block 3 may be improved (e.g., due to the improved frequency domain diversity across code blocks). In other words, if frequency interleaving were to only be applied within a given code block, the channel imperfection or issue in the frequency domain range typically associated with the code block 3 may reduce the likelihood that the receiver is able to successfully receive and decode the code block 3. Therefore, the PAPR-based frequency interleaving described herein may improve the performance of communications.

As indicated above, FIG. 7 is provided as an example. Other examples may differ from what is described with respect to FIG. 7.

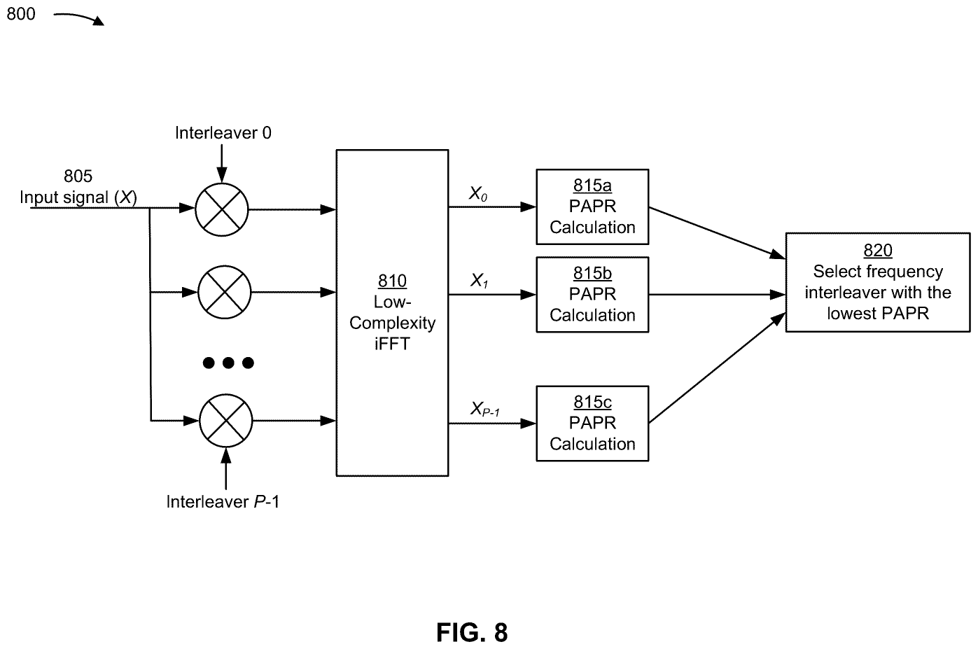

FIG. 8 is a diagram of an example 800 associated with PAPR-based frequency interleaving, in accordance with the present disclosure. The PAPR-based frequency interleaving operation described in connection with FIG. 8 may be performed by a transmitter described herein, such as the transmitter 605. For example, the PAPR-based frequency interleaving operation described in connection with FIG. 8 may be performed by the transmitter 605 as described in connection with reference number 625, reference number 630, reference number 635, and/or reference number 640.

For example, as shown in FIG. 8, the PAPR-based frequency interleaving may include the transmitter interleaving an input signal 805 with a set of P frequency interleavers and then selecting and transmitting an overall signal that exhibits the lowest PAPR. For example, the selection operation may include the transmitter interleaving the input signal 805 (e.g., X) via the set of P frequency interleavers (e.g., frequency interleaver 0 to frequency interleaver P−1). The input signal 805 may include a set of data bits, a set of resource elements, and/or a set of constellation symbols (e.g., QAM symbols), among other examples.

As shown by reference number 810, the transmitter may perform an iFFT operation for each interleaved sequence. The iFFT operation may be a low-complexity iFFT because the transmitter may only perform the iFFT for the interleaved portions of each interleaved sequence (e.g., as described in more detail elsewhere herein). An output of the iFFT component may include a set of interleaved signals (e.g., X₀ to X_{P-1}) The transmitter may determine (e.g., calculate) a PAPR for each interleaved signal (e.g., as shown by reference number 815a, reference number 815b, and reference number 815c). A determination of a PAPR for a given signal may include determining, in the time domain, a sample (e.g., an I/Q sample) of the given signal with a highest amplitude. The power of the identified sample may represent the peak power of the given signal. The transmitter may determine an average power of the given signal according to:

$${P}_{a v g} = \frac{1}{N} {\sum }_{n = 0}^{N - 1} {\vert x ( n ) \vert}^{2} ,$$

where P_{avg} is the average power, Nis a total number of samples of the given signal, and x(n) is the sample values (e.g., power values) of the given signal. The transmitter may determine the PAPR for the given signal according to:

$$P A P R = \frac{{P}_{P e a k}}{{P}_{a v g}} ,$$

where P_{Peak} is the peak power of the given signal. As shown by reference number 820, the transmitter may select a frequency interleaver that is associated with a lowest PAPR value (e.g., may select the frequency interleaver that produces an interleaved signal having the lowest PAPR value). The PAPR-based frequency interleaving may result in a reduced PAPR for the transmitted signal (e.g., the signal transmitted as described in connection with reference number 655). Additionally, performing the PAPR-based frequency interleaving may be reduce the complexity and/or reduce the processing overhead associated with PAPR reduction.

As indicated above, FIG. 8 is provided as an example. Other examples may differ from what is described with respect to FIG. 8.

FIG. 9 is a diagram illustrating an example process 900 performed, for example, at a transmitter or an apparatus of a transmitter, in accordance with the present disclosure. Example process 900 is an example where the apparatus or the transmitter (e.g., the transmitter 605, a UE 120, or a network node 110) performs operations associated with PAPR-based frequency interleaving.

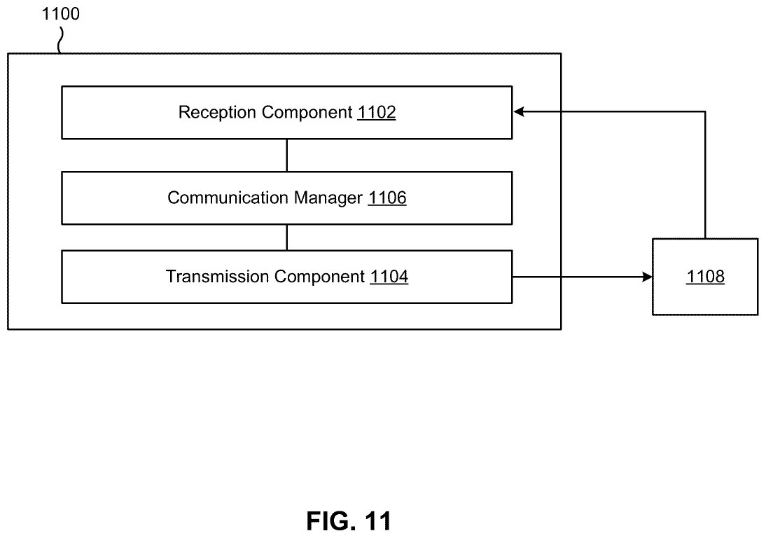

As shown in FIG. 9, in some aspects, process 900 may include transmitting an indication of a frequency interleaver, from a set of frequency interleavers, that provides an interleaved sequence for a communication, the frequency interleaver being selected based on a PAPR of the interleaved sequence (block 910). For example, the transmitter (e.g., using transmission component 1104 and/or communication manager 1106, depicted in FIG. 11) may transmit an indication of a frequency interleaver, from a set of frequency interleavers, that provides an interleaved sequence for a communication, the frequency interleaver being selected based on a PAPR of the interleaved sequence, as described above.

As further shown in FIG. 9, in some aspects, process 900 may include transmitting the communication including the interleaved sequence, and an index of the interleaved sequence being associated with an input signal that is interleaved via the frequency interleaver when the input signal is in a frequency domain (block 920). For example, the transmitter (e.g., using transmission component 1104 and/or communication manager 1106, depicted in FIG. 11) may transmit the communication including the interleaved sequence, and an index of the interleaved sequence being associated with an input signal that is interleaved via the frequency interleaver when the input signal is in a frequency domain, as described above.

Process 900 may include additional aspects, such as any single aspect or any combination of aspects described below and/or in connection with one or more other processes described elsewhere herein.

In a first aspect, process 900 includes communicating capability information indicating support for applying the set of frequency interleavers for the communication.

In a second aspect, alone or in combination with the first aspect, the communication is associated with a receiver, and communicating the capability information includes receiving the capability information indicating whether the receiver supports receiving the communication in association with applying the set of frequency interleavers.

In a third aspect, alone or in combination with one or more of the first and second aspects, the communication is associated with a receiver, and communicating the capability information includes transmitting, to the receiver, the capability information.

In a fourth aspect, alone or in combination with one or more of the first through third aspects, the capability information indicates support for applying the set of frequency interleavers to the input signal to generate a signal for the communication.

In a fifth aspect, alone or in combination with one or more of the first through fourth aspects, the capability information is associated with radio resource control signaling, uplink control information signaling, or downlink control information signaling.

In a sixth aspect, alone or in combination with one or more of the first through fifth aspects, process 900 includes communicating an indication of the set of frequency interleavers.

In a seventh aspect, alone or in combination with one or more of the first through sixth aspects, communicating the indication of the set of frequency interleavers includes transmitting the indication of the set of frequency interleavers.

In an eighth aspect, alone or in combination with one or more of the first through seventh aspects, communicating the indication of the set of frequency interleavers includes receiving the indication of the set of frequency interleavers.

In a ninth aspect, alone or in combination with one or more of the first through eighth aspects, the indication of the set of frequency interleavers is associated with radio resource control signaling or downlink control information signaling.

In a tenth aspect, alone or in combination with one or more of the first through ninth aspects, the indication of the frequency interleaver indicates that the frequency interleaver is to be applied for a time interval.

In an eleventh aspect, alone or in combination with one or more of the first through tenth aspects, the time interval includes a slot, a subframe, or one or more OFDM symbols.

In a twelfth aspect, alone or in combination with one or more of the first through eleventh aspects, the input signal is interleaved via the frequency interleaver prior to an iFFT operation.

In a thirteenth aspect, alone or in combination with one or more of the first through twelfth aspects, the input signal is an input to an iFFT component associated with generating a signal for the communication.

In a fourteenth aspect, alone or in combination with one or more of the first through thirteenth aspects, the frequency interleaver interleaves, in the frequency domain, at least one of one or more bits, one or more resource elements, or one or more constellation symbols.

In a fifteenth aspect, alone or in combination with one or more of the first through fourteenth aspects, the one or more resource elements are associated with different code blocks.

In a sixteenth aspect, alone or in combination with one or more of the first through fifteenth aspects, process 900 includes generating, using the input signal, a set of interleaved sequences associated with respective frequency interleavers of the set of frequency interleavers, and selecting the frequency interleaver from the set of frequency interleavers in association with the PAPR being a lowest PAPR among PAPRs associated with respective interleaved sequences of the set of interleaved sequences.

In a seventeenth aspect, alone or in combination with one or more of the first through sixteenth aspects, generating the set of interleaved sequences includes applying, for each interleaved sequence of the set of interleaved sequences, an iFFT to only portions of that interleaved sequence that have been interleaved.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a receiver or an apparatus of a receiver, in accordance with the present disclosure. Example process 1000 is an example where the apparatus or the receiver (e.g., the receiver 610, a UE 120, or a network node 110) performs operations associated with PAPR-based frequency interleaving.

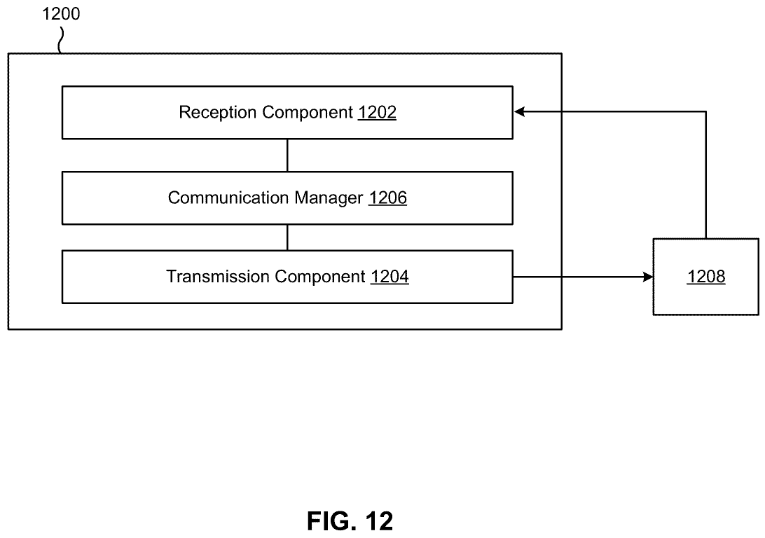

As shown in FIG. 10, in some aspects, process 1000 may include receiving an indication of a frequency interleaver, from a set of frequency interleavers, that provides an interleaved sequence for a communication, the frequency interleaver being selected based on a PAPR of the interleaved sequence (block 1010). For example, the receiver (e.g., using reception component 1202 and/or communication manager 1206, depicted in FIG. 12) may receive an indication of a frequency interleaver, from a set of frequency interleavers, that provides an interleaved sequence for a communication, the frequency interleaver being selected based on a PAPR of the interleaved sequence, as described above.

As further shown in FIG. 10, in some aspects, process 1000 may include receiving the communication including the interleaved sequence, and an index of the interleaved sequence being associated with an input signal that is interleaved via the frequency interleaver when the input signal is in a frequency domain (block 1020). For example, the receiver (e.g., using reception component 1202 and/or communication manager 1206, depicted in FIG. 12) may receive the communication including the interleaved sequence, and an index of the interleaved sequence being associated with an input signal that is interleaved via the frequency interleaver when the input signal is in a frequency domain, as described above.

Process 1000 may include additional aspects, such as any single aspect or any combination of aspects described below and/or in connection with one or more other processes described elsewhere herein.

In a first aspect, process 1000 includes communicating capability information indicating support for applying the set of frequency interleavers for the communication.

In a second aspect, alone or in combination with the first aspect, the communication is associated with a transmitter, and communicating the capability information includes receiving the capability information indicating whether the transmitter supports transmitting the communication in association with applying the set of frequency interleavers.

In a third aspect, alone or in combination with one or more of the first and second aspects, the communication is associated with a transmitter, and communicating the capability information includes transmitting, to the transmitter, the capability information.

In a fourth aspect, alone or in combination with one or more of the first through third aspects, the capability information indicates support for applying the set of frequency interleavers to the input signal to generating a signal for the communication.

In a fifth aspect, alone or in combination with one or more of the first through fourth aspects, the capability information is associated with radio resource control signaling, uplink control information signaling, or downlink control information signaling.

In a sixth aspect, alone or in combination with one or more of the first through fifth aspects, process 1000 includes communicating an indication of the set of frequency interleavers.

In a seventh aspect, alone or in combination with one or more of the first through sixth aspects, communicating the indication of the set of frequency interleavers includes transmitting the indication of the set of frequency interleavers.

In an eighth aspect, alone or in combination with one or more of the first through seventh aspects, communicating the indication of the set of frequency interleavers includes receiving the indication of the set of frequency interleavers.

In a ninth aspect, alone or in combination with one or more of the first through eighth aspects, the indication of the set of frequency interleavers is associated with radio resource control signaling or downlink control information signaling.

In a tenth aspect, alone or in combination with one or more of the first through ninth aspects, the indication of the frequency interleaver indicates that the frequency interleaver is to be applied for a time interval.

In an eleventh aspect, alone or in combination with one or more of the first through tenth aspects, the time interval includes a slot, a subframe, or one or more OFDM symbols.

In a twelfth aspect, alone or in combination with one or more of the first through eleventh aspects, the input signal is interleaved via the frequency interleaver prior to an iFFT operation.

In a thirteenth aspect, alone or in combination with one or more of the first through twelfth aspects, the input signal is an input to an iFFT component associated with generating a signal for the communication.

In a fourteenth aspect, alone or in combination with one or more of the first through thirteenth aspects, the frequency interleaver interleaves, in the frequency domain, at least one of one or more bits, one or more resource elements, or one or more constellation symbols.

In a fifteenth aspect, alone or in combination with one or more of the first through fourteenth aspects, the one or more resource elements are associated with different code blocks.

In a sixteenth aspect, alone or in combination with one or more of the first through fifteenth aspects, receiving the communication includes applying, to a signal associated with the communication, an FFT to transform the signal to the frequency domain, and deinterleaving, in accordance with the frequency interleaver, the signal in the frequency domain.

In a seventeenth aspect, alone or in combination with one or more of the first through sixteenth aspects, deinterleaving the signal in the frequency domain includes deinterleaving, prior to performing a log-likelihood ratio generation operation, the signal in the frequency domain.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a transmitter, or a transmitter may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 or the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE or the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE or the network node described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE or the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit an indication of a frequency interleaver, from a set of frequency interleavers, that provides an interleaved sequence for a communication, the frequency interleaver being selected based on a peak-to-average power ratio (PAPR) of the interleaved sequence. The transmission component 1104 may transmit the communication including the interleaved sequence, an index of the interleaved sequence being associated with an input signal that is interleaved via the frequency interleaver when the input signal is in a frequency domain.

The communication manager 1106, the reception component 1102, and/or the transmission component 1104 may communicate capability information indicating support for applying the set of frequency interleavers for the communication.

The communication manager 1106, the reception component 1102, and/or the transmission component 1104 may communicate an indication of the set of frequency interleavers.

The communication manager 1106 may generate, using the input signal, a set of interleaved sequences associated with respective frequency interleavers of the set of frequency interleavers.

The communication manager 1106 may select the frequency interleaver from the set of frequency interleavers in association with the PAPR being a lowest PAPR among PAPRs associated with respective interleaved sequences of the set of interleaved sequences.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a receiver, or a receiver may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 or the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE or the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE or the network node described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE or the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive an indication of a frequency interleaver, from a set of frequency interleavers, that provides an interleaved sequence for a communication, the frequency interleaver being selected based on a PAPR of the interleaved sequence. The reception component 1202 may receive the communication including the interleaved sequence, an index of the interleaved sequence being associated with an input signal that is interleaved via the frequency interleaver when the input signal is in a frequency domain.

The communication manager 1206, the reception component 1202, and/or the transmission component 1204 may communicate capability information indicating support for applying the set of frequency interleavers for the communication.

The communication manager 1206, the reception component 1202, and/or the transmission component 1204 may communicate an indication of the set of frequency interleavers.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a transmitter, comprising: transmitting an indication of a frequency interleaver, from a set of frequency interleavers, that provides an interleaved sequence for a communication, the frequency interleaver being selected based on a peak-to-average power ratio (PAPR) of the interleaved sequence; and transmitting the communication including the interleaved sequence, and an index of the interleaved sequence being associated with an input signal that is interleaved via the frequency interleaver when the input signal is in a frequency domain.

Aspect 2: The method of Aspect 1, further comprising: communicating capability information indicating support for applying the set of frequency interleavers for the communication.

Aspect 3: The method of Aspect 2, wherein the communication is associated with a receiver, and wherein communicating the capability information comprises: receiving the capability information indicating whether the receiver supports receiving the communication in association with applying the set of frequency interleavers.

Aspect 4: The method of any of Aspects 2-3, wherein the communication is associated with a receiver, and wherein communicating the capability information comprises: transmitting, to the receiver, the capability information.

Aspect 5: The method of any of Aspects 2-4, wherein the capability information indicates support for applying the set of frequency interleavers to the input signal to generate a signal for the communication.

Aspect 6: The method of any of Aspects 2-5, wherein the capability information is associated with radio resource control signaling, uplink control information signaling, or downlink control information signaling.

Aspect 7: The method of any of Aspects 1-6, further comprising: communicating an indication of the set of frequency interleavers.

Aspect 8: The method of Aspect 7, wherein communicating the indication of the set of frequency interleavers comprises: transmitting the indication of the set of frequency interleavers.

Aspect 9: The method of Aspect 7, wherein communicating the indication of the set of frequency interleavers comprises: receiving the indication of the set of frequency interleavers.

Aspect 10: The method of any of Aspects 7-9, wherein the indication of the set of frequency interleavers is associated with radio resource control signaling or downlink control information signaling.

Aspect 11: The method of any of Aspects 1-10, wherein the indication of the frequency interleaver indicates that the frequency interleaver is to be applied for a time interval.

Aspect 12: The method of Aspect 11, wherein the time interval includes: a slot, a subframe, or one or more orthogonal frequency division multiplexing (OFDM) symbols.

Aspect 13: The method of any of Aspects 1-12, wherein the input signal is interleaved via the frequency interleaver prior to an inverse fast Fourier transform (iFFT) operation.

Aspect 14: The method of any of Aspects 1-13, wherein the input signal is an input to an inverse fast Fourier transform (iFFT) component associated with generating a signal for the communication.

Aspect 15: The method of any of Aspects 1-14, wherein the frequency interleaver interleaves, in the frequency domain, at least one of: one or more bits, one or more resource elements, or one or more constellation symbols.

Aspect 16: The method of Aspect 15, wherein the one or more resource elements are associated with different code blocks.

Aspect 17: The method of any of Aspects 1-16, further comprising: generating, using the input signal, a set of interleaved sequences associated with respective frequency interleavers of the set of frequency interleavers; and selecting the frequency interleaver from the set of frequency interleavers in association with the PAPR being a lowest PAPR among PAPRs associated with respective interleaved sequences of the set of interleaved sequences.

Aspect 18: The method of Aspect 17, wherein generating the set of interleaved sequences comprises: applying, for each interleaved sequence of the set of interleaved sequences, an inverse fast Fourier transform (iFFT) to only portions of that interleaved sequence that have been interleaved.

Aspect 19: A method of wireless communication performed by a receiver, comprising: receiving an indication of a frequency interleaver, from a set of frequency interleavers, that provides an interleaved sequence for a communication, the frequency interleaver being selected based on a peak-to-average power ratio (PAPR) of the interleaved sequence; and receiving the communication including the interleaved sequence, and an index of the interleaved sequence being associated with an input signal that is interleaved via the frequency interleaver when the input signal is in a frequency domain.

Aspect 20: The method of Aspect 19, further comprising: communicating capability information indicating support for applying the set of frequency interleavers for the communication.

Aspect 21: The method of Aspect 20, wherein the communication is associated with a transmitter, and wherein communicating the capability information comprises: receiving the capability information indicating whether the transmitter supports transmitting the communication in association with applying the set of frequency interleavers.

Aspect 22: The method of any of Aspects 20-21, wherein the communication is associated with a transmitter, and wherein communicating the capability information comprises: transmitting, to the transmitter, the capability information.

Aspect 23: The method of any of Aspects 20-22, wherein the capability information indicates support for applying the set of frequency interleavers to the input signal to generating a signal for the communication.

Aspect 24: The method of any of Aspects 20-23, wherein the capability information is associated with radio resource control signaling, uplink control information signaling, or downlink control information signaling.

Aspect 25: The method of any of Aspects 19-24, further comprising: communicating an indication of the set of frequency interleavers.

Aspect 26: The method of Aspect 25, wherein communicating the indication of the set of frequency interleavers comprises: transmitting the indication of the set of frequency interleavers.

Aspect 27: The method of Aspect 25, wherein communicating the indication of the set of frequency interleavers comprises: receiving the indication of the set of frequency interleavers.

Aspect 28: The method of Aspect 25, wherein the indication of the set of frequency interleavers is associated with radio resource control signaling or downlink control information signaling.

Aspect 29: The method of any of Aspects 19-28, wherein the indication of the frequency interleaver indicates that the frequency interleaver is to be applied for a time interval.

Aspect 30: The method of Aspect 29, wherein the time interval includes: a slot, a subframe, or one or more orthogonal frequency division multiplexing (OFDM) symbols.

Aspect 31: The method of any of Aspects 19-30, wherein the input signal is interleaved via the frequency interleaver prior to an inverse fast Fourier transform (iFFT) operation.

Aspect 32: The method of any of Aspects 19-31, wherein the input signal is an input to an inverse fast Fourier transform (iFFT) component associated with generating a signal for the communication.

Aspect 33: The method of any of Aspects 19-32, wherein the frequency interleaver interleaves, in the frequency domain, at least one of: one or more bits, one or more resource elements, or one or more constellation symbols.

Aspect 34: The method of Aspect 33, wherein the one or more resource elements are associated with different code blocks.

Aspect 35: The method of any of Aspects 19-34, wherein receiving the communication comprises: applying, to a signal associated with the communication, a fast Fourier transform (FFT) to transform the signal to the frequency domain; and deinterleaving, in accordance with the frequency interleaver, the signal in the frequency domain.

Aspect 36: The method of Aspect 35, wherein deinterleaving the signal in the frequency domain comprises: deinterleaving, prior to performing a log-likelihood ratio generation operation, the signal in the frequency domain.

Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.

Aspect 38: An apparatus for wireless communication at a device, the apparatus comprising one or more memories and one or more processors coupled to the one or more memories, the one or more processors configured to cause the device to perform the method of one or more of Aspects 1-36.

Aspect 39: An apparatus for wireless communication, the apparatus comprising at least one means for performing the method of one or more of Aspects 1-36.

Aspect 40: A non-transitory computer-readable medium storing code for wireless communication, the code comprising instructions executable by one or more processors to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

Aspect 42: A device for wireless communication, the device comprising a processing system that includes one or more processors and one or more memories coupled with the one or more processors, the processing system configured to cause the device to perform the method of one or more of Aspects 1-36.

Aspect 43: An apparatus for wireless communication at a device, the apparatus comprising one or more memories and one or more processors coupled to the one or more memories, the one or more processors individually or collectively configured to cause the device to perform the method of one or more of Aspects 1-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitter for wireless communication, comprising:
one or more memories; and
one or more processors, coupled to the one or more memories, configured to cause the transmitter to:
transmit an indication of a frequency interleaver, from a set of frequency interleavers, that provides an interleaved sequence for a communication, the frequency interleaver being selected based on a peak-to-average power ratio (PAPR) of the interleaved sequence; and
transmit the communication, including the interleaved sequence, and an index of the interleaved sequence being associated with an input signal that is interleaved via the frequency interleaver when the input signal is in a frequency domain.

2. The transmitter of claim 1, wherein the one or more processors are further configured to cause the transmitter to:
communicate capability information indicating support for applying the set of frequency interleavers for the communication.

3. The transmitter of claim 2, wherein the capability information indicates support for applying the set of frequency interleavers to the input signal to generate a signal for the communication.

4. The transmitter of claim 1, wherein the one or more processors are further configured to cause the transmitter to:
communicate an indication of the set of frequency interleavers.

5. The transmitter of claim 1, wherein the indication of the frequency interleaver indicates that the frequency interleaver is to be applied for a time interval.

6. The transmitter of claim 5, wherein the time interval includes:
a slot,
a subframe, or
one or more orthogonal frequency division multiplexing (OFDM) symbols.

7. The transmitter of claim 1, wherein the input signal is interleaved via the frequency interleaver prior to an inverse fast Fourier transform (iFFT) operation.

8. The transmitter of claim 1, wherein the frequency interleaver interleaves, in the frequency domain, at least one of:
one or more bits,
one or more resource elements, or
one or more constellation symbols.

9. The transmitter of claim 8, wherein the one or more resource elements are associated with different code blocks.

10. The transmitter of claim 1, wherein the one or more processors are further configured to cause the transmitter to:
generate, using the input signal, a set of interleaved sequences associated with respective frequency interleavers of the set of frequency interleavers; and
select the frequency interleaver from the set of frequency interleavers in association with the PAPR being a lowest PAPR among PAPRs associated with respective interleaved sequences of the set of interleaved sequences.

11. The transmitter of claim 10, wherein the one or more processors, to cause the transmitter to generate the set of interleaved sequences, are configured to cause the transmitter to:
apply, for each interleaved sequence of the set of interleaved sequences, an inverse fast Fourier transform (iFFT) to only portions of that interleaved sequence that have been interleaved.

12. A receiver for wireless communication, comprising:
one or more memories; and
one or more processors, coupled to the one or more memories, configured to cause the receiver to:
receive an indication of a frequency interleaver, from a set of frequency interleavers, that provides an interleaved sequence for a communication, the frequency interleaver being selected based on a peak-to-average power ratio (PAPR) of the interleaved sequence; and
receive the communication including the interleaved sequence, an index of the interleaved sequence being associated with an input signal that is interleaved via the frequency interleaver when the input signal is in a frequency domain.

13. The receiver of claim 12, wherein the one or more processors are further configured to cause the receiver to:
communicate capability information indicating support for applying the set of frequency interleavers for the communication.

14. The receiver of claim 13, wherein the capability information is associated with radio resource control signaling, uplink control information signaling, or downlink control information signaling.

15. The receiver of claim 12, wherein the one or more processors are further configured to cause the receiver to:
communicate an indication of the set of frequency interleavers.

16. The receiver of claim 15, wherein the indication of the set of frequency interleavers is associated with radio resource control signaling or downlink control information signaling.

17. The receiver of claim 12, wherein the indication of the frequency interleaver indicates that the frequency interleaver is to be applied for a time interval.

18. The receiver of claim 12, wherein the input signal is an input to an inverse fast Fourier transform (iFFT) component associated with generating a signal for the communication.

19. The receiver of claim 12, wherein the frequency interleaver interleaves, in the frequency domain, at least one of:
one or more bits,
one or more resource elements, or
one or more constellation symbols.

20. The receiver of claim 12, wherein the one or more processors, to cause the receiver to receive the communication, are configured to cause the receiver to:
apply, to a signal associated with the communication, a fast Fourier transform (FFT) to transform the signal to the frequency domain; and
deinterleave, in accordance with the frequency interleaver, the signal in the frequency domain.

21. The receiver of claim 20, wherein the one or more processors, to cause the receiver to deinterleave the signal in the frequency domain, are configured to cause the receiver to:
deinterleave, prior to performing a log-likelihood ratio generation operation, the signal in the frequency domain.

22. A method of wireless communication performed by a transmitter, comprising:
transmitting an indication of a frequency interleaver, from a set of frequency interleavers, that provides an interleaved sequence for a communication, the frequency interleaver being selected based on a peak-to-average power ratio (PAPR) of the interleaved sequence; and
transmitting the communication including the interleaved sequence, and an index of the interleaved sequence being associated with an input signal that is interleaved via the frequency interleaver when the input signal is in a frequency domain.

23. The method of claim 22, further comprising:
communicating capability information indicating support for applying the set of frequency interleavers for the communication.

24. The method of claim 22, further comprising:
communicating an indication of the set of frequency interleavers.

25. The method of claim 22, wherein the indication of the frequency interleaver indicates that the frequency interleaver is to be applied for a time interval.

26. The method of claim 22, wherein the input signal is interleaved via the frequency interleaver prior to an inverse fast Fourier transform (iFFT) operation.

27. The method of claim 22, further comprising:
generating, using the input signal, a set of interleaved sequences associated with respective frequency interleavers of the set of frequency interleavers; and
selecting the frequency interleaver from the set of frequency interleavers in association with the PAPR being a lowest PAPR among PAPRs associated with respective interleaved sequences of the set of interleaved sequences.

28. A method of wireless communication performed by a receiver, comprising:
receiving an indication of a frequency interleaver, from a set of frequency interleavers, that provides an interleaved sequence for a communication, the frequency interleaver being selected based on a peak-to-average power ratio (PAPR) of the interleaved sequence; and
receiving the communication including the interleaved sequence, and an index of the interleaved sequence being associated with an input signal that is interleaved via the frequency interleaver when the input signal is in a frequency domain.

29. The method of claim 28, wherein receiving the communication comprises:
applying, to a signal associated with the communication, a fast Fourier transform (FFT) to transform the signal to the frequency domain; and
deinterleaving, in accordance with the frequency interleaver, the signal in the frequency domain.

30. The method of claim 29, wherein deinterleaving the signal in the frequency domain comprises:
deinterleaving, prior to performing a log-likelihood ratio generation operation, the signal in the frequency domain.
